(19) United States
(12) Patent Application Publication
(10) Pub. No.: US 2013/0074670 A1
(43) Pub. Date: Mar. 28, 2013

(54) WELD TAB MACHINING APPARATUS

(71) Applicants: Brian David Albin, Chicago, IL (US); Lawrence Michael Grycko, Lockport, IL (US)

(72) Inventors: Brian David Albin, Chicago, IL (US); Lawrence Michael Grycko, Lockport, IL (US)

(73) Assignee: GENERAL ELECTRIC COMPANY, Schenectady, NY (US)

(21) Appl. No.: 13/245,294

(22) Filed: Sep. 26, 2011

(51) Int. Cl. B23D 47/02; B23D 45/00; B23D 47/08

(52) U.S. Cl. 83/478; 83/651; 83/544

(57) ABSTRACT

An apparatus for machining a weld tab on an article. In one embodiment, the apparatus includes: a base member including at least one rolling element for contacting an underlying surface, the base member having a leading end and a trailing end; a cutting apparatus operably connected to the base member, the cutting apparatus including: a cutting member positioned proximate the leading end of the base member, the cutting member sized to coincide with a size of the weld tab; and a handle member proximate the trailing end and operably connected to the cutting member, the handle member for modifying a position of the cutting member relative to the base member.

### BACKGROUND OF THE INVENTION

The subject matter disclosed herein relates to an apparatus for machining weld tabs. Specifically, the subject matter disclosed herein relates to an apparatus for removing weld tabs on machines (e.g., turbine rotors).

Weld tabs are intentionally added sections of metal used to aid in the welding of one or more metal components together. In the case of a turbine (e.g., a steam turbine), weld tabs may be introduced into the repair of parts (e.g., turbine wheels) for allowing those wheels to be effectively welded to a turbine rotor. While these tabs are introduced intentionally to aid in welding, they are removed upon completion of the welding task for which they were previously introduced. As such, these tabs are conventionally removed (e.g., via machining or otherwise cutting) post-welding.

Conventionally, removal of weld tabs on turbines is performed using a large and unwieldy cutting tool. This cutting tool is traditionally mounted having a base that requires several operators to transport and maneuver. The size and unwieldy nature of this conventional cutting tool can cause long maintenance cycles and high costs.

### BRIEF DESCRIPTION OF THE INVENTION

An apparatus for machining a weld tab on an article is disclosed. In one embodiment, the apparatus includes: a base member including at least one rolling element for contacting an underlying surface, the base member having a leading end and a trailing end; a cutting apparatus operably connected to the base member, the cutting apparatus including: a cutting member positioned proximate the leading end of the base member, the cutting member sized to coincide with a size of the weld tab; and a handle member proximate the trailing end and operably connected to the cutting member, the handle member for modifying a position of the cutting member relative to the base member.

A first aspect of the invention includes an apparatus for machining a weld tab on an article, the apparatus including: a base member including at least one rolling element for contacting an underlying surface, the base member having a leading end and a trailing end; a cutting apparatus operably connected to the base member, the cutting apparatus including: a cutting member positioned proximate the leading end of the base member, the cutting member sized to coincide with a size of the weld tab; and a handle member proximate the trailing end and operably connected to the cutting member, the handle member for modifying a position of the cutting member relative to the base member.

A second aspect of the invention includes an apparatus for machining a weld tab on a turbine rotor, the apparatus including: a base member configured to slide along an underlying surface, the base member having a leading end and a trailing end; a cutting apparatus operably connected to the base member, the cutting apparatus including: a cutting member positioned proximate the leading end of the base member, the cutting member sized to fit between adjacent rotor wheels on the turbine rotor; and a handle member proximate the trailing end and pivotably connected to the cutting member, the handle member for modifying a position of the cutting member relative to the base member; and a locking member for affixing the base member to the underlying surface, the locking member substantially restraining movement of the base member relative to the underlying surface.

A third aspect of the invention includes an apparatus for machining a weld tab on a turbine rotor, the apparatus including: a base member configured to slide along an underlying surface, the base member having a leading end and a trailing end; and a cutting apparatus operably connected to the base member, the cutting apparatus including: a rotatable cutting member positioned proximate the leading end of the base member, the rotatable cutting member sized to fit between adjacent rotor wheels on the turbine rotor; a shield covering at least a portion of the rotatable cutting member, leaving an exposed portion of the rotatable cutting member; and a handle member proximate the trailing end and pivotably connected to the rotatable cutting member, wherein actuating of the handle member moves the exposed portion of the rotatable cutting member closer to the adjacent rotor wheels on the turbine rotor.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a three-dimensional perspective view of a weld tab removal apparatus according to aspects of the invention.

FIG. 2 shows a side view of a portion of an apparatus according to aspects of the invention.

FIG. 3 shows a three-dimensional side view of a portion of an apparatus according to aspects of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The subject matter disclosed herein relates to an apparatus for machining weld tabs on an article. Specifically, the subject matter disclosed herein relates to an apparatus for removing weld tabs on one or more articles, e.g., turbines (and an associated rotor).

As noted herein, conventional approaches for removal of weld tabs on articles (e.g., turbines) are performed using one or more large and unwieldy cutting tools. These cutting tools are traditionally mounted having a base that requires several operators to transport and maneuver. The size and unwieldy nature of these conventional cutting tools can induce long maintenance cycles and high costs.

In contrast to conventional weld tab removal tools, aspects of the invention include an apparatus for machining a weld tab having a base member including at least one rolling element for contacting an underlying surface. As described herein, the base member can include (or be operably connected to) a rolling element such as a wheel, a track and/or belt system, etc. The base member is configured to allow the apparatus to easily move between locations in a machining environment (e.g., a turbine repair environment). Although the apparatus is mobile, aspects of the invention allow for affixing of the base member to a surface, thereby restricting movement of the apparatus when desired. As described herein, the base member and other aspects of the apparatus allow for a single operator (e.g., a human operator) to substantially perform the machining functions (e.g., weld tab machining/removal function) with little or no aid from additional operators. This allows for reduced manpower and time in machining turbine components. As is further described herein, the handle-cutting member configuration allows the single operator to perform the machining functions at a safe distance from the cutting member. Additionally, the “dead-man” switch on the handle prevents unwanted actuation of the cutting member.

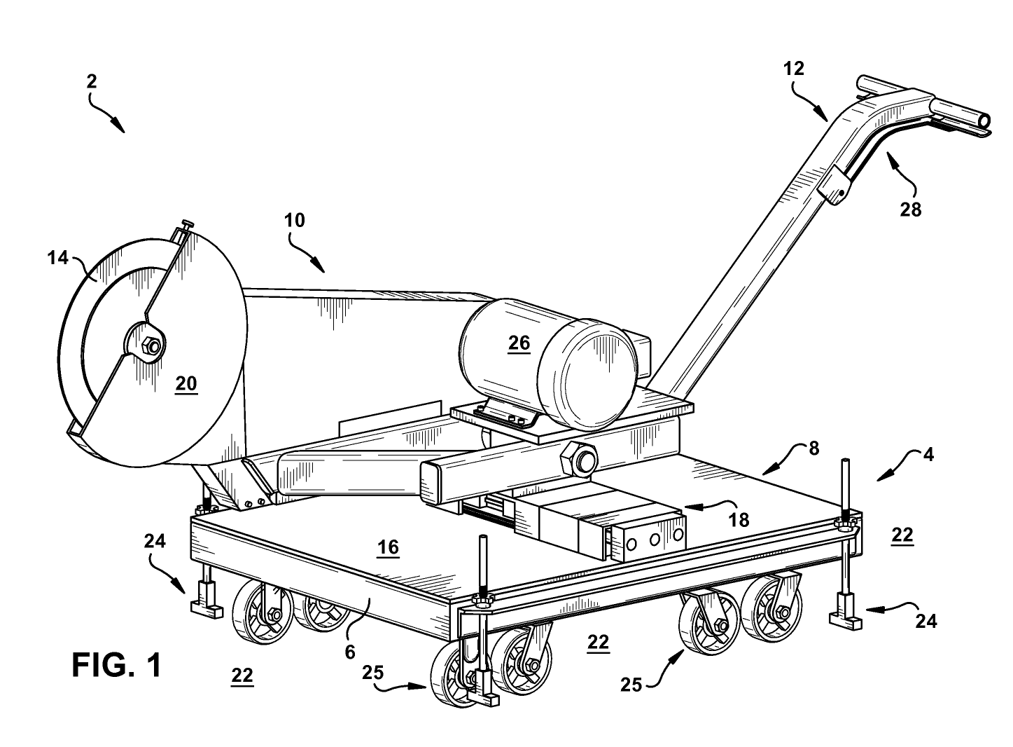

FIG. 1 shows a three-dimensional perspective view of an apparatus 2 for machining weld tabs (e.g., in a turbine rotor) according to embodiments of the invention. The apparatus 2 can include a base member 4 having a leading end 6 and a trailing end 8. The term “leading end” generally refers to the working/machining end of the apparatus 2, while the term “trailing end” generally refers to the end of the apparatus 2 at which an operator can operate the apparatus 2. Also shown included in the apparatus 2 is a cutting apparatus 10 operably connected to the base member 4. In some cases, the cutting apparatus 10 can be mounted on the base member 4 (e.g., via bolts, screws, set-in mounting, etc.), or in other cases the cutting apparatus 10 can be integral with the base member 4. For example, the cutting apparatus 10 can be linked or otherwise operably connected with an actuation member, or handle 12, which allows a cutting member 14 to engage with a portion of a turbine rotor (not shown) when the handle 12 is pushed downward (e.g., toward base member 4) by an operator.

As shown, the cutting apparatus 10 can include the cutting member 14 positioned proximate the leading end 6 of the base member 4. In some embodiments, the cutting member 14 can include a rotatable blade, e.g., a circular blade. In other cases, the cutting member 14 can include a band-based or belt-based blade member. It is understood that other cutting members 14 are also compatible with the cutting apparatus 10. In any case, in some cases, the cutting member 14 is sized to coincide with a size of the weld tab being cut. That is, in some cases, the cutting member 14 is sized such that it not substantially wider than a width of the weld tab to be cut. In some cases, the cutting member 14 is sized to fit between adjacent rotor wheels on a turbine rotor (not shown), such that in some embodiments, the cutting member 14 has a blade width of approximately ⅛ of an inch to ⅞ of an inch. This blade width can allow for at least ½ inch of clearance between the blade and a sidewall of an adjacent rotor wheel.

Also shown in the apparatus 2 of FIG. 1 is the handle member 12 located proximate the trailing end 8 (e.g., operably connected to the base member 4 near the trailing end 8). The handle member 12 can further be operably connected to the cutting member 14 via one or more conventional mechanisms, including bolts, screws, latches, dovetail connections, etc. The handle member 12 can in some cases be pivotably attached to the cutting member 14 such that movement of the handle member 12 can modify a position of the cutting member 14 relative to the base member 4 (e.g., relative to an upper surface 16 of the base member 4). That is, the handle member 12 can actuate movement of the cutting member 14 at least partially vertically and/or horizontally for aiding in machining a portion of a turbine rotor (not shown).

The apparatus 2 can further include a positioning member 18 for sliding the cutting member 14 (and/or the cutting apparatus 10) along the upper surface 16 of the base member 4. This positioning member 18 can include a track-based system that allows for movement of the cutting member 14 along the upper surface 16, particularly from the leading end 6 to trailing end 8, and vice versa. The positioning member 18 can allow an operator to slide the cutting member 14 closer or farther from a portion of the turbine for machining The positioning member 18 can be fixable in a position along the upper surface 16 of the base member 4, such that after fixing the positioning member 18, movement of the cutting member 14 can be actuated by the handle member 12 (e.g., via a pivotable connection).

In some embodiments, the cutting apparatus 10 can include a shield 20 for covering at least a portion of the cutting member 14, leaving an exposed portion of the cutting member. In some cases, the shield 20 is composed of two approximately half-moon shaped sections (only one shown). One of the sections may be removed to allow for exposure and use of the cutting member 14 in performing the machining functions described herein. In some cases, a section of the shield may be fixed on the cutting apparatus 10, thereby exposing an outwardly facing portion of the cutting member 14 for machining one or more tabs on a turbine rotor (e.g., an at least partially overhanging turbine rotor). In some cases, the exposed portion of the cutting member 14 faces substantially away from the underlying surface 22 (e.g., a machining environment floor) on which the base member 4 stands.

Also shown included in the apparatus 2 are locking members 24 for engaging the base member 4 with the underlying surface 22. The locking members 24 can each be configured to substantially restrain movement of the base member 4 relative to the underlying surface 22. Shown in this depiction, a plurality of locking members 24 can include “T-bar” or “T-shaped” members configured to engage with holes or slots in the underlying surface 22. For example, where the underlying surface 22 includes slats or other partitioned sections, the locking member(s) 24 can be configured to penetrate apertures between the partitioned sections and lock into place (e.g., via turning and locking) When not locked in place, the base member 4 can be configured to slide or otherwise move along the underlying surface 22 using one or more rolling members 25, which can include wheels (as depicted), tracks, belts, etc.

Also shown in FIG. 1, the apparatus 2 can include a motor 26 operably connected to the cutting member 14, where the motor is configured to drive the cutting member 14. The motor may be a conventional electric and/or gas motor configured to rotate one or more disc(s), belt(s), drive shaft(s), etc. to cause movement of the cutting member 14, which may be coupled to the disc(s), belt(s) and/or drive shaft(s) in any conventional manner. The handle member 12 can include a switch 28 (or other triggering mechanism) for actuating the motor 26. The switch 28 can be located on an underside (downwardly facing side) of the handle member 12 such that release of the switch 28 is relatively effortless for an operator. Conversely, in this embodiment, actuation of the switch 28 requires active compression by the operator, thereby providing a safety function. That is, the underlying (or, “dead-man”) switch 28 can help an operator avoid actuating the cutting member 14 in undesirable situations (e.g., when the operator is not located at the trailing end 8 of the apparatus 2).

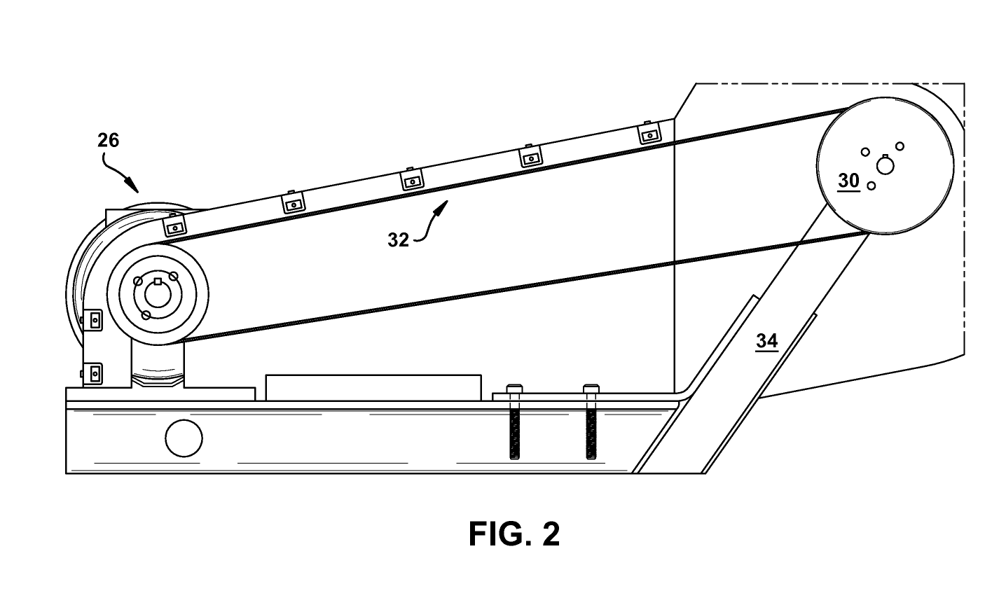

FIG. 2 shows a side cut-away view of a portion of the cutting apparatus 10 (FIG. 1), including the motor 26 coupled to a driven disc (or shaft, or spool) 30 connected with the cutting member 14 via a belt 32 (or other conventional coupling mechanism). As shown, the driven disc (or shaft, or spool) 30 can be mounted on a sliding/pivoting member 34 (e.g., a shaft), which may be operably coupled with the handle member 12 (not visible in this side view).

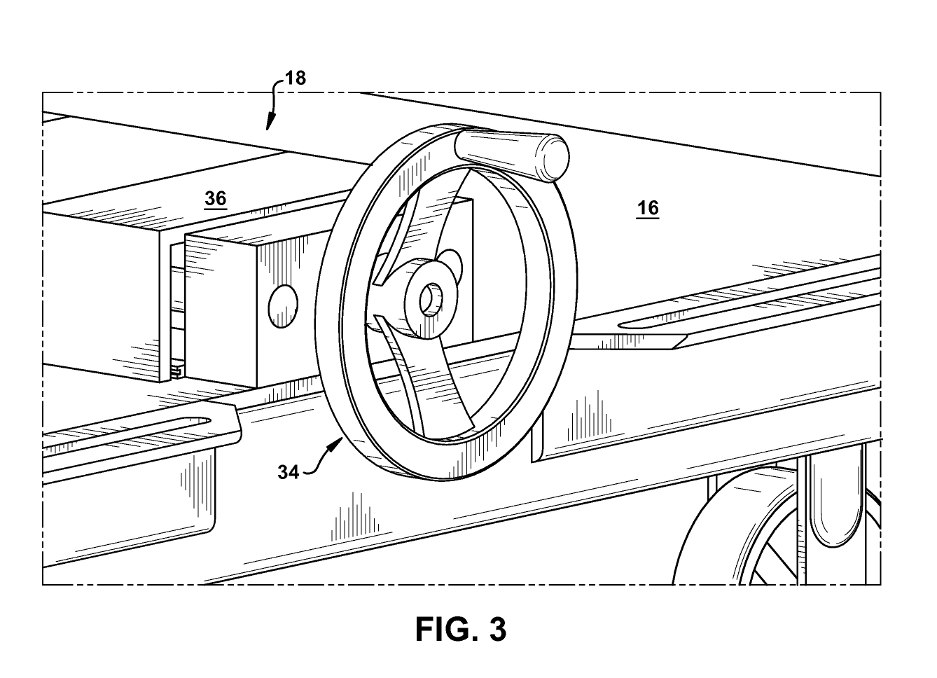

FIG. 3 shows a three-dimensional perspective view of the positioning member 18 located on the upper surface 16 of the base member 4. As shown, the positioning member 18 can include a wheel (e.g., a crank wheel) 34 configured to actuate movement of a housing 36 coupled to the cutting apparatus 10. Actuation of the wheel 34 either clockwise or counter-clockwise causes movement of the cutting apparatus 10 along the upper surface 16.

As described herein, in contrast to conventional weld tab removal tools, aspects of the invention include an apparatus for machining weld tabs that is easily transported. Further, the apparatus is configured to allow for actuation of the cutting member while an operator is located at a safe distance from the cutting member. Additionally, the apparatus is configured to allow a single operator to perform the machining functions previously performed by two or more people.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An apparatus for machining a weld tab on an article, the apparatus comprising:
a base member including at least one rolling element for contacting an underlying surface, the base member having a leading end and a trailing end; and
a cutting apparatus operably connected to the base member, the cutting apparatus including:
a cutting member positioned proximate the leading end of the base member, the cutting member sized to coincide with a size of the weld tab; and
a handle member proximate the trailing end and operably connected to the cutting member, the handle member for modifying a position of the cutting member relative to the base member.

2. The apparatus of claim 1, further comprising a positioning member for sliding the cutting member along an upper face of the base member.

3. The apparatus of claim 2, wherein the positioning member is fixable in a position along the upper face of the base member.

4. The apparatus of claim 1, wherein the at least one rolling element includes a plurality of wheels.

5. The apparatus of claim 1, wherein the cutting element has a blade width of approximately ⅛ of an inch to ⅞ of an inch.

6. The apparatus of claim 1, further comprising a shield for covering at least a portion of the cutting member, leaving an exposed portion of the cutting member.

7. The apparatus of claim 6, wherein the exposed portion of the cutting member faces substantially away from the underlying surface.

8. The apparatus of claim 1, further comprising at least one locking member for engaging the base member with the underlying surface, the at least one locking member substantially restraining movement of the base member relative to the underlying surface.

9. The apparatus of claim 1, wherein the handle member and the cutting member are pivotably connected.

10. The apparatus of claim 1, further comprising a motor operably connected to the cutting member, the motor for driving the cutting member.

11. The apparatus of claim 10, further comprising a switch operably connected to the motor and an underside of the handle, the switch for actuating movement of the motor.

12. The apparatus of claim 1, wherein the article is a turbine rotor, and wherein the cutting member is further sized to fit between adjacent rotor wheels on the turbine rotor.

13. An apparatus for machining a weld tab on a turbine rotor, the apparatus comprising:
a base member configured to slide along an underlying surface, the base member having a leading end and a trailing end;
a cutting apparatus operably connected to the base member, the cutting apparatus including:
a cutting member positioned proximate the leading end of the base member, the cutting member sized to fit between adjacent rotor wheels on the turbine rotor; and
a handle member proximate the trailing end and pivotably connected to the cutting member, the handle member for modifying a position of the cutting member relative to the base member; and
a locking member for affixing the base member to the underlying surface, the locking member substantially restraining movement of the base member relative to the underlying surface.

14. The apparatus of claim 13, further comprising a positioning member for sliding the cutting member along an upper face of the base member.

15. The apparatus of claim 14, wherein the positioning member is fixable in a position along the upper face of the base member.

16. The apparatus of claim 13, wherein the cutting element has a blade width of approximately ⅛ of an inch to ⅞ of an inch.

17. The apparatus of claim 13, further comprising a shield for covering at least a portion of the cutting member, leaving an exposed portion of the cutting member.

18. The apparatus of claim 17, wherein the exposed portion of the cutting member faces substantially away from the underlying surface.

18. (canceled)

19. The apparatus of claim 18, further comprising:
a motor operably connected to the cutting member, the motor for driving the cutting member; and
a switch operably connected to the motor and an underside of the handle, the switch for actuating movement of the motor.

20. An apparatus for machining a weld tab on a turbine rotor, the apparatus comprising:
a base member configured to slide along an underlying surface, the base member having a leading end and a trailing end; and
a cutting apparatus operably connected to the base member, the cutting apparatus including:
a rotatable cutting member positioned proximate the leading end of the base member, the rotatable cutting member sized to fit between adjacent rotor wheels on the turbine rotor;
a shield covering at least a portion of the rotatable cutting member, leaving an exposed portion of the rotatable cutting member; and
a handle member proximate the trailing end and pivotably connected to the rotatable cutting member, wherein actuating of the handle member moves the exposed portion of the rotatable cutting member closer to the adjacent rotor wheels on the turbine rotor.
